(19) United States
(12) Patent Application Publication
(10) Pub. No.: US 2006/0083975 A1
(43) Pub. Date: Apr. 20, 2006

(54) Fuel cell stack mock-up and pressure measuring instrument of fuel cell balance of plant using fuel cell stack mock-up

(75) Inventor: Sang-Yeoul Ahn, Seoul (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Seoul (KR)

(21) Appl. No.: 11/014,856

(22) Filed: Dec. 20, 2004

(30) Foreign Application Priority Data
Oct. 15, 2004 (KR) 10-2004-0082679

(51) Int. Cl. H01M 8/04; H01M 8/10; H01M 2/02

(52) U.S. Cl. 429/32; 429/33; 429/34; 429/26

(57) ABSTRACT

A pressure variation before and after providing hydrogen and oxygen to a fuel cell stack is measured substantially identically to the actual situation without using an actual fuel cell stack, thereby enabling to feasibly design a fuel cell Balance Of Plant (BOP) at low cost.

### CROSS-REFERENCE TO RELATED APPLICATIONS

The present application is based on, and claims priority from, Korean Application Serial Number 10-2004-0082679, filed on Oct. 15, 2004, the disclosure of which is hereby incorporated by reference herein in its entirety.

### FIELD OF THE INVENTION

The present invention relates to an instrument that measures pressure loss of a fuel cell Balance Of Plant (BOP) by using a fuel cell stack mock-up without using an actual fuel cell stack.

### BACKGROUND OF THE INVENTION

Generally, a fuel cell stack contains a plurality of fuel cell units, which are stacked upon each other, and generates electric energy by receiving hydrogen and air from the exterior.

In the fuel cell stack, heat, water, and gas consumption occur due to electrochemical reaction of hydrogen and oxygen. Therefore, various supplementary devices are required to drive the fuel cell stack in consideration of the above phenomenon.

Hereinafter, the supplementary apparatus required to drive the fuel cell stack will be called a fuel cell Balance Of Plant (BOP). The fuel cell BOP and fuel cell stack constitute a fuel cell system.

The fuel cell BOP includes pipe lines to supply and discharge hydrogen and air to and from the fuel cell stack. The pipe lines should properly be configured to effectively drive the fuel cell system.

When configuring the pipe lines, a plurality of tests is required to measure the pressure variation of hydrogen and air that are provided and exhausted from the fuel cell stack through the pipe lines of the fuel cell BOP connected to the fuel cell stack.

The pipe lines of the fuel cell BOP can be designed to optimize the efficiency of the configuration thereof based on data obtained in the above tests.

The most reliable data is obtained when the pipe lines of the fuel cell BOP are connected to an actual fuel cell stack. However, the potential malfunction that occurs during laboratory work may decrease the performance and duration of the expensive fuel cell stack.

### SUMMARY OF THE INVENTION

Embodiments of the present invention are provided to measure the variation of pressure before and after supplying or discharging hydrogen and oxygen to a fuel cell stack mock-up without using an actual fuel cell stack, thereby feasibly designing a fuel cell BOP at low cost.

According to the first preferred embodiment of the present invention, a fuel cell stack mock-up includes a mock-up case mounted with a hydrogen channel and air channel therein. A hydrogen exhaust passage is connected to the hydrogen channel and exhausts a certain amount of hydrogen (that passes through the hydrogen channel) to the exterior of the mock-up case. An air exhaust passage is connected to the air channel and exhausts a certain amount of air (that passes through the air channel) to the exterior of the mock-up case. A hydrogen flow regulator is provided in the mock-up case to exhaust hydrogen waste (calculated by a hydrogen usage simulation equation) to the hydrogen exhaust passage among hydrogen that passes through the hydrogen channel. An air flow regulator is provided in the mock-up case to exhaust air wastage (calculated by an air usage simulation equation) to the air exhaust passage among air that passes through the air channel.

According to the second preferred embodiment, a pressure measuring instrument using the fuel cell stack mock-up includes a hydrogen influx pipe and hydrogen effluent pipe that are connected to an inlet and outlet of the hydrogen channel of the mock-up case, respectively. An air influx pipe and air effluent pipe are connected to an inlet and outlet of the air channel of the mock-up case, respectively. Hydrogen pressure measuring instruments are provided at the hydrogen influx pipe and hydrogen effluent pipe, respectively. Air pressure measuring instruments are positioned at the air influx pipe and air effluent pipe, respectively. A controller calculates pressure differences by receiving signals from the hydrogen pressure measuring instruments and air pressure measuring instruments.

### BRIEF DESCRIPTION OF THE DRAWINGS

For a better understanding of the nature and objects of the present invention, reference should be made to the following detailed description with the accompanying drawings, in which:

FIG. 1 illustrates a structure of a fuel cell stack mock-up according to an embodiment of the present invention; and

FIG. 2 depicts a pressure measuring instrument of a fuel cell Balance Of Plant (BOP) using a fuel cell stack mock-up according to an embodiment of the present invention.

### DETAILED DESCRIPTION OF THE PREFERRED EMBODIMENTS

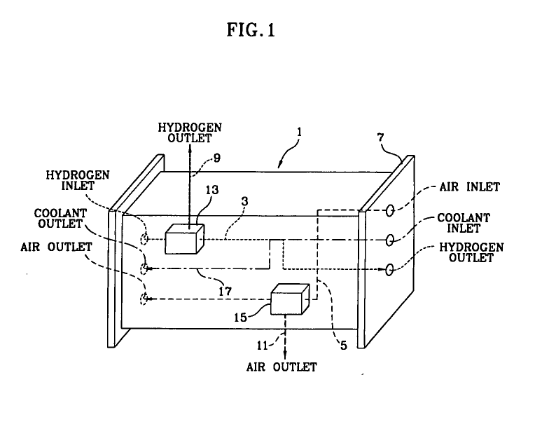

Referring now to FIG. 1, a fuel cell stack mock-up 1 according to an embodiment of the present invention includes a mock-up case 7 with a hydrogen channel 3 and air channel 5 mounted therein. A hydrogen exhaust passage 9 is connected to the hydrogen channel 3 and exhausts a certain amount of hydrogen (that passes through the hydrogen channel 3) to the exterior of the mock-up case 7. An air exhaust passage 11 is connected to the air channel 5 and exhausts a certain amount of air (that passes through the air channel 5) to the exterior of the mock-up case 7. A hydrogen flow regulator 13 is provided in the mock-up case 7 to exhaust hydrogen waste (calculated by a hydrogen usage simulation equation) to the hydrogen exhaust passage 9 among hydrogen that passes through the hydrogen channel 3. An air flow regulator 15 is provided in the mock-up case 7 to exhaust air waste (calculated by an air usage simulation equation) to the air exhaust passage 11 among air that passes through the air channel 5.

The mock-up case 7 is preferably a full-sized scale and identical in appearance to an actual fuel cell stack.

The hydrogen usage simulation equation and air usage simulation equation are used to calculate the amount of hydrogen and air consumed in the actual fuel cell stack during generating a required output. The formulas are provided below.

When the amount of the required output in relation to the actual fuel cell stack is assumed to be 0-240 kW as the reference value,

the hydrogen usage simulation equation is: hydrogen gas waste (kg/s)=(1.05×10⁻⁸)×(hydrogen usage ratio)×(fuel cell stack output)/(fuel cell average voltage), and

the air usage simulation equation is: air waste (kg/s)=(3.57×10⁻⁷)×(air usage ratio)×(fuel cell stack output)/(fuel cell average voltage),

where the usage ratios of hydrogen and air are variable depending on the kinds and structure of the fuel cell stack.

The hydrogen flow regulator 13 is provided at a connection point of the hydrogen channel 3 and hydrogen exhaust passage 9. The air flow regulator 15 is provided at a connection point of the air channel 5 and air exhaust passage 11.

The fuel cell stack mock-up 1 is further equipped with a coolant channel 17 in the mock-up case 7 in the embodiment of the present invention. This formation imitates more identically the actual fuel cell stack in which the coolant is provided and discharged to absorb and cool down the reaction heat of hydrogen and oxygen.

The fuel cell stack mock-up 1 thus constructed is connected to a fuel cell Balance Of Plant (BOP). Then, the fuel cell stack mock-up 1 is provided with hydrogen, air, and coolant. The hydrogen waste and air waste are calculated according to the pre-estimated required output to discharge hydrogen and air to the outside of the fuel cell stack mock-up 1 by adjusting the hydrogen flow regulator 13 and air flow regulator 15. Next, the leftover hydrogen, air, and coolant are exhausted from the fuel cell stack mock-up 1.

Thus, the fuel cell stack mock-up 1 can be embodied substantially identically to the actual fuel cell stack in movement of hydrogen and air that are provided, consumed, and exhausted to the fuel cell stack to possess the required power.

The fuel cell system using the fuel cell stack mock-up 1 instead of an actual fuel cell stack measures the efficiency of the pipe line structure of the fuel cell BOP to apply the result to an actual fuel cell BOP, thereby increasing the efficiency of the pipe line structure of the fuel cell BOP at low cost.

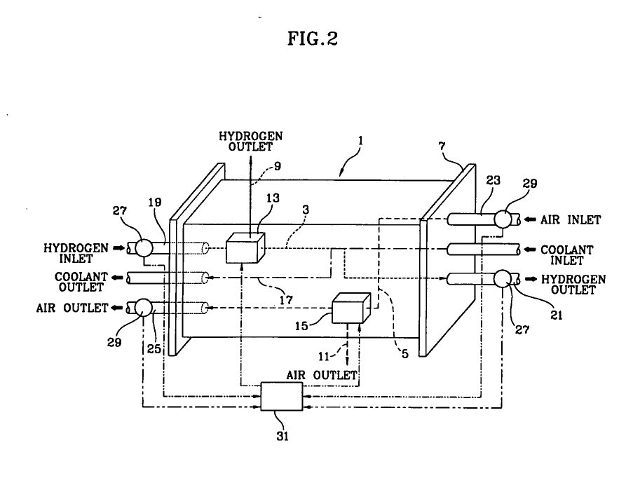

In order to measure the efficiency of the pipe line structure of the fuel cell BOP, a pressure measuring instrument shown in FIG. 2 according to an embodiment of the present invention is preferably used.

The pressure measuring instrument according to the embodiment of the present invention includes a hydrogen influx pipe 19 and hydrogen effluent pipe 21 connected to the inlet and outlet of the hydrogen channel 3 of the mock-up case 7, respectively. An air influx pipe 23 and air effluent pipe 25 are connected to the inlet and outlet of the air channel 5 of the mock-up case 7, respectively. Hydrogen pressure measuring instruments 27 are equipped at the hydrogen influx pipe 19 and hydrogen effluent pipe 21, respectively. Air pressure measuring instruments 29 are positioned at the air influx pipe 23 and air effluent pipe 25, respectively. A controller 31 computes pressure differences by receiving signals from the hydrogen pressure measuring instruments 27 and air pressure measuring instruments 29.

The controller 31 preferably controls both the hydrogen flow regulator 13 and air flow regulator 15.

The pressure measuring instrument is placed at the pipe line structure of the fuel cell BOP, connected to the fuel cell stack mock-up 1, and automatically calculates each pressure difference before and after supplying and exhausting hydrogen and air to the fuel cell stack mock-up.

The efficiency of the pipe line of the fuel cell BOP can be estimated via the above pressure variation of hydrogen and air and is applied to the actual design.

As apparent from the foregoing, there is an advantage at least in that a pressure variation before and after providing and discharging hydrogen and oxygen to and from the fuel cell stack can be estimated substantially identically to the actual situation without using an actual fuel cell stack, thereby enabling to feasibly design a fuel cell BOP at low cost.

What is claimed is:

1. A fuel cell stack mock-up, comprising:
a mock-up case provided with a hydrogen channel and an air channel therein;
a hydrogen exhaust passage connected to said hydrogen channel and that exhausts a certain amount of hydrogen passed through said hydrogen channel to the exterior of said mock-up case;
an air exhaust passage connected to said air channel that exhausts a certain amount of air passed through said air channel to the exterior of said mock-up case;
a hydrogen flow regulator provided in said mock-up case to exhaust hydrogen waste calculated by a hydrogen usage simulation equation to said hydrogen exhaust passage among hydrogen passed through said hydrogen channel; and
an air flow regulator provided in said mock-up case to exhaust air waste calculated by an air usage simulation equation to said air exhaust passage among air passed through said air channel.

2. The mock-up as defined in claim 1, wherein said mock-up case is a full-sized scale and substantially identical in appearance to an actual fuel cell stack.

3. The mock-up as defined in claim 1, wherein said hydrogen flow regulator is provided at a connection point of said hydrogen channel and said hydrogen exhaust passage and said air flow regulator is provided at a connection point of said air channel and said air exhaust passage.

4. The mock-up as defined in claim 1, wherein said mock-up case is further provided with a coolant channel therein.

5. A pressure measuring instrument using said fuel cell stack mock-up as defined in claim 1, wherein said instrument includes:
a hydrogen influx pipe and a hydrogen effluent pipe connected to an inlet and outlet of said hydrogen channel of said mock-up case, respectively;
an air influx pipe and an air effluent pipe connected to an inlet and outlet of said air channel of said mock-up case, respectively;
hydrogen pressure measuring instruments provided at said hydrogen influx pipe and said hydrogen effluent pipe, respectively;
air pressure measuring instruments positioned at said air influx pipe and said air effluent pipe, respectively; and
a controller to compute pressure differences by receiving signals from said hydrogen pressure measuring instruments and said air pressure measuring instruments.

6. The instrument as defined in claim 5, wherein said controller controls both said hydrogen flow regulator and said air flow regulator.
